(19) United States
(12) Patent Application Publication
(10) Pub. No.: US 2023/0183123 A1
(43) Pub. Date: Jun. 15, 2023

(54) ANTIBACTERIAL GLASS COMPOSITION, METHOD OF MANUFACTURING ANTIBACTERIAL GLASS POWDER USING ANTIBACTERIAL GLASS COMPOSITION, AND HOME APPLIANCE INCLUDING ANTIBACTERIAL GLASS COMPOSITION

(71) Applicant: LG ELECTRONICS INC., Seoul (KR)

(72) Inventors: Daesung KIM, Seoul (KR); Namjin KIM, Seoul (KR); Young Seok KIM, Seoul (KR)

(21) Appl. No.: 17/924,153

(22) PCT Filed: Nov. 9, 2021
(86) PCT No.: PCT/KR2021/016274

§ 371 Date: Nov. 9, 2022

(30) Foreign Application Priority Data
Dec. 15, 2020 (KR) 10-2020-0175660

(51) Int. Cl. C03C 3/066; C03C 3/078; C03C 3/097; B29C 45/00

(52) U.S. Cl. CPC C03C 3/066; C03C 3/078; C03C 3/097; B29C 45/0013; B29K 2509/08

(57) ABSTRACT

An antibacterial glass composite, a method of manufacturing antibacterial glass powder using an antibacterial glass composite, and a home appliance including an antibacterial glass composite. The antibacterial glass composition secures antibacterial activity and water resistance at the same time using a content ratio of a modified oxide and a network-forming oxide. As a result, as the antibacterial glass composition, the method for preparing the antibacterial glass power, and the household electrical appliance comprising the antibacterial glass composite use antimicrobial having non-elution characteristics, remarkable effects may be exhibited in preventing bacterial or mold contamination when used as a coating agent on a component element that is in contract with drinking water.

### CROSS-REFERENCE TO RELATED PATENT APPLICATIONS

This application is a U.S. National Stage Application under 35 U.S.C. § 371 of PCT Application No. PCT/KR 2021/016274, filed Nov. 9, 2021, which claims priority to Korean Patent Application No. 10-2020-0175660, filed Dec. 15, 2020, whose entire disclosures are hereby incorporated by reference.

### BACKGROUND

### 1. Field

An antibacterial glass composite, a method of manufacturing antibacterial glass powder using an antibacterial glass composition, and a home appliance including an antibacterial glass composition are disclosed herein.

### 2. Background

Microorganisms, such as germs, fungi, and bacteria, are ubiquitous in our living spaces (e.g., water purifiers, refrigerators, ovens, and washing machines). If these microbes get into our bodies, they cause life-threatening infections. Accordingly, there is a need for an antibacterial glass composite that is capable of controlling the spread of microorganisms in household items, such as water purifiers, refrigerators, ovens, and washing machines.

Among parts where plastic injection molding is used in these home appliances, bacteria and mold grow in some parts exposed to moisture, thereby causing problems in appearance or use environment. Bacterial inhabiting home appliances are very diverse, and main strains may be different for each part, but the parts exposed to moisture are generally more likely to inhabit Pseudomonas aeruginosa. Accordingly, antibacterial agents must have antibacterial performance against these strains. In addition, such antibacterial agents must be strictly selected from materials with low toxicity to the human body and the environment, that is, materials with durability against high temperatures.

The antibacterial agents may be broadly divided into inorganic and organic antibacterial agents. The organic antibacterial agent exhibits excellent antibacterial performance because it expresses antibacterial activity against bacteria by eluting a material with antibacterial performance toward a surface by water. However, durability might be reduced when the organic antibacterial agent is applied to a washing machine. In addition, with respect to the organic antibacterial agent concerns have recently been raised about the harmfulness of the eluted material to the human body and the environment, and there is a risk of decomposition during an injection process of the organic antibacterial agent due to its low decomposition temperature.

The inorganic antibacterial agents may have significantly lower elution properties than the organic antibacterial agents, and may secure durability against high temperatures. However, there might be a problem of interfacial wettability with plastic injection molding. As silver (Ag) is used as an antibacterial material in most cases, its high price limits its application.

Conventional non-elution antibacterial glass may not mean that the entire glass is non-elution, but rather, may refer to glass composed of water-insoluble glass properties and icons or crystalline components eluted for the purpose of antibacterial properties.

As a result, in order to express antibacterial activity, ions or crystal phases expressing antibacterial activity should be eluted. However, the conventional elution antibacterial glass does not exhibit long-term durability and has limits in safety when applied to parts that come into contact with drinking water.

Accordingly, embodiments disclosed herein is to address the above-noted and other problems and to provide an antibacterial glass composition that exhibits an antibacterial activity lasting permanently even if glass does not react with water at all, unlike the conventional elution mechanism, a method of manufacturing antibacterial glass powder using an antibacterial glass composition, and a home appliance including an antibacterial glass composition.

Further, another object is to provide an antibacterial glass composition that forms a strong glass structure not eluting in water by strictly controlling each component of a glass composition and participating Zn and Sn ions exhibiting antibacterial performance in a network formation structure, thereby exhibiting antibacterial activity without being eluted in water by controlling a surface charge of glass, a method of manufacturing antibacterial glass powder using an antibacterial glass composition, and a home appliance including an antibacterial glass composition.

Still further, a further object is to provide an antibacterial glass composition that exhibits an excellent effect in preventing contamination of bacteria and mold, when used as a coating agent for a group of parts coming into contact with driving water by strictly controlling each component of a glass composition and its component ratio, a method of manufacturing antibacterial glass powder using an antibacterial glass composition, and a home appliance including an antibacterial glass composition.

Aspects are not limited to the above ones, and other aspects and advantages that are not mentioned above can be clearly understood from the following description and may be more clearly understood from the embodiments set forth herein. Additionally, the aspects and advantages may be realized via means and combinations thereof that are described in the appended claims.

To solve the above technical problems, an antibacterial glass composition, a method of manufacturing antibacterial glass powder using an antibacterial glass composition, and a home appliance including an antibacterial glass composition according to embodiments disclosed herein may control zinc (Zn) and tin (Sn) ions eluted to realize an antibacterial function to perform network formation by using the content ratio of a modifying oxide and a network-forming oxide, thereby securing both antibacterial activity and water resistance.

The antibacterial glass composition, the method of manufacturing antibacterial glass powder using an antibacterial glass composition, and the home appliance including an antibacterial glass composition according to embodiments disclosed herein may control metal ions in glass to allow a surface charge of glass, that is, a zeta potential to have a positive charge, so that the positive charge may attract and kill negatively charged bacteria by creating a charged atmosphere in which bacterial cannot grow. As a result, in the antibacterial glass composition, a method of manufacturing antibacterial glass powder using an antibacterial glass composition, and a home appliance including an antibacterial glass composition according to embodiments disclosed herein, the antibacterial glass composition may be antibacterial agents exhibiting non-dissolving properties, and thus, effective in preventing contamination of bacteria and mold, when used as a coating agent for a group of parts coming into contact with driving water.

The antibacterial glass composition may include 26 to 50 wt % of silicon dioxide (SiO2); 0.5 to 4 wt % of at least one of boric oxide (B2O3) and phosphorous pentoxide (P2O5); 15 to 27 wt % of at least one of sodium oxide (Na2O) and potassium oxide (K2O); 3 to 20 wt % of at least one of calcium oxide (CaO), magnesium oxide (MgO), and tungsten trioxide (WO3); and 22 to 44 wt % of zinc oxide (ZnO) and tin oxide (SnO). The antibacterial glass composition may further include 0.1 wt % or less of at least one of silver oxide (Ag2O), silver phosphate (Ag3PO4), and silver nitrate (AgNO3).

Embodiments disclosed herein may have following advantageous effects. According to embodiments disclosed herein, a strong glass structure not eluting in water may be formed by strictly controlling each component of a glass composition and participating Zn and Sn ions exhibiting antibacterial performance in a network formation structure, thereby exhibiting antibacterial activity without being eluted in water by controlling a surface charge of glass.

Further, embodiments disclosed herein may be a water insoluble antibacterial agent composed of the multi-purpose antibacterial component, thereby being used permanently when used as a coating material for glass shelves and an additive for plastic injection molded products. Furthermore, embodiments disclosed herein may be an antibacterial agent exhibiting non-dissolving properties, when used as a coating agent for a group of parts coming into contact with drinking water, thereby exhibiting an excellent effect in preventing contamination of bacteria, mold and the like.

Specific effects are described along with the above-described effects in the section of Detailed Description.

### BRIEF DESCRIPTION OF DRAWINGS

FIG. 1 is a flow chart of a method of manufacturing antibacterial glass powder according to an embodiment.

### DETAILED DESCRIPTION

The above-described aspects, features, and advantages are specifically described hereunder with reference to the accompanying drawings such that one having ordinary skill in the art to which embodiments disclosed herein pertain may easily implement the technical spirit. In the disclosure, detailed descriptions of known technologies in relation to the disclosure are omitted if they are deemed to make the gist of the disclosure unnecessarily vague. Hereinafter, embodiments are specifically described with reference to the accompanying drawings. In the drawings, identical reference numerals can denote identical or similar components.

The singular forms “a”, “an” and “the” are intended to include the plural forms as well, unless explicitly indicated otherwise. It should be further understood that the terms “comprise” or “include” for example, set forth herein, are not interpreted as necessarily including all the stated components or steps but can be interpreted as excluding some of the stated components or steps or can be interpreted as including additional components or steps.

Hereinafter, an antibacterial glass composition, a method for preparing antibacterial glass powder, and a home appliance including an antibacterial glass composition according embodiments will be described. Unlike the conventional elution mechanism, the antibacterial glass composition according to embodiments may have an antibacterial action persisting permanently even if the glass does not react with water at all.

In order to take advantage of the fact that an intermediate oxide can act as both a modifying oxide and a mesh forming oxide when forming glass, the glass composition according to embodiments may help Zn and Sn ions provided to exhibit antibacterial performance to participate in a network forming structure by controlling each component and its component ratio, thereby forming a strong glass structure configured not to elute in water. In addition, the antibacterial glass composition may exhibit antibacterial activity without eluting in water by controlling the surface charge of glass.

As described above, the antibacterial glass composition according to embodiments may control the Zn and Sn ions eluted to implement the antibacterial function to form the network using a content ratio of modifying oxide and network-forming oxide, thereby achieving antibacterial activity and water resistance at the same time. In the mechanism configured to exhibit the antibacterial activity according to embodiments disclosed herein, metal ions in glass allow a surface charge of glass, that is, a zeta potential to have a positive charge, so that the positive charge may attract and kill negatively charged bacteria by creating a charged atmosphere in which bacterial cannot grow.

Elements for manufacturing an antibacterial glass composition having excellent durability may be largely divided into two types.

First, it is a glass matrix that determines chemical durability by forming a glass structure. The glass matrix performs a role similar to the role of a carrier provided in a conventional inorganic antibacterial agent, that is, a role of dispersing a material exhibiting the antibacterial properties on the surface.

If there is a difference, the conventional carrier is in the form of supporting an antibacterial component but in embodiments disclosed herein, the metal material exhibiting antibacterial properties may be made to exist in the glass substrate in the form of ions. In order to make the glass substrate having excellent durability, not only a content ratio of glass-forming agents (e.g., SiO2 and B2O3) is important, but it is also a very important factor that mechanical properties of glass can non-linearly change based on a mixed alkali effect in glass, that is, a ratio of alkali components.

Second, there is the effect of the metal component contained in the glass. In other words, it can be said that the metal component is the main factor for exhibiting the antibacterial performance, and there is a big difference in the antibacterial properties of each component. An optimized design of the composition ratio of antibacterial glass is important, because differences in durability could appear depending on a state of ionic and covalent bonds due to interactions with components in the glass substrate.

The antibacterial glass composition according to an embodiment may contain 26 to 50% by weight (hereinafter, wt %) of SiO2, 0.5 to 4 wt % of at least one of B2O3 and P2O5, 15 to 27 wt % of at least one of Na2O and K2O, 3 to 20 wt % of at least one of CaO, MgO, and WO3, and 22 to 44 wt % of at least one of ZnO and SnO. In addition, the antibacterial glass composition according to an embodiment may further include 0.1 wt % or less of at least one of Ag2O, Ag3PO4, and AgNO3.

The above-described antibacterial glass composition according to an embodiment may be a water-insoluble antibacterial agent composed of a multipurpose antibacterial component, and may be used permanently when used as a coating material for glass shelves and an additive for plastic injection products. In addition, the antibacterial glass composition according to an embodiment may be an antibacterial agent exhibiting non-dissolving properties, and may exhibit an excellent effect in preventing contamination of bacterial and mold when used as a coating agent for a group of parts that come into contact with driving water.

Hereinafter, the role of each component contained in the antibacterial glass composition and its content will be described.

SiO2, B2O3, and P2O5 may be network-forming oxides, which form a frame structure of glass and key components that enable vitrification of covalent bonding. SiO2 is a glass former that enables vitrification, and is a key component that acts as a framework in the structural aspect of glass. When SiO2 is contained more than an appropriate amount, the viscosity may increase during the process of melting glass, and thus, workability and yield could be deteriorated in a cooling process. Although not acting as a direct component exhibiting antibacterial activity, SiO2 forms less OH-groups on a glass surface, compared to P2O5 which is a typical network-forming oxide.

Accordingly, SiO2 is advantageous to positively charge the glass surface caused by metal ions in the glass. SiO2 may be added in a content ratio of 26 to 50 wt % of the antibacterial glass composition according to embodiments disclosed herein, and 30 to 36 wt % may be the range. When the content amount of SiO2 is less than 26 wt %, oxygenation might appear due to a lack of a network-forming oxide leaving a vitrification region, or a heterogeneity phenomenon in which transparent glass is mixed might occur. Conversely, when the added content amount of SiO2 exceeds 50 wt %, it could be difficult to control the surface charge of the glass to be a positive value and the antibacterial activity might be deteriorated.

B2O3 and P2O5 may be key components that enable sufficient vitrification together with SiO2 as representative network-forming oxides. B2O3 and P2O5 have low melting points and are used to lower an eutectic point of the melt. In addition, when they are melted for vitrification, B2O3 and P2O5 act to increase solubility of rigid components (e.g., Al2O3, CuO, etc.), thereby helping to make a homogeneous glass. However, when B2O3 and P2O5 are added above a predetermined level, there might be a problem of weakening a bonding structure of the glass to reduce water resistance, for example. Accordingly, B2O3 and P2O5 may be used in trace amounts only for lowering the melting point in order to realize water-insoluble antibacterial glass.

At least one of B2O3 and P2O5 may be added in a content ratio of 0.5 to 4 wt % based on a total weight of the antibacterial glass composition according to embodiments disclosed herein. When the content amount of at least one of B2O3 and P2O5 is less than 0.5 wt %, the flux could be insufficient enough to leave the vitrification region, which might cause unmelting. Conversely, when the content amount of at least one of B2O3 and P2O5 exceeds 4 wt %, structural problems of B and P in the network-forming structure could cause a decrease in water resistance due to the nature of the element itself. In embodiments disclosed herein, the content amount of SiO2 may be higher than that of B2O3, because it is advantageous to secure water resistance when the amount of SiO2 added is higher than that of B2O3.

Alkali oxides, such as Na2O and K2O, are oxides that act as a network molding for non-crosslinking in the glass composition. These components may not be vitrified alone, but vitrification may be possible when mixed with a network former, such as SiO2 and B2O3, in a predetermined ratio. If only one of the SiO2 and B2O3 components is contained in the glass composition, the durability of the glass might be weakened in the vitrified region. However, if two or more of the SiO2 and B2O3 components are contained in the glass composition, the durability of the glass may be improved again based on the ratio, which is called the mixed alkali effect.

Accordingly, alkali oxides, such as Na2O and K2O, may improve antibacterial activity using a point that they first occupy a modulation oxide site in the glass. In addition, alkali oxides, such as Na2O and K2O, may contribute to meshes formed by ZnO and SnO, which are intermediate oxides, to enhance durability, thereby contributing to the antibacterial activity by surface charge and water insoluble properties.

At least one of Na2O and K2O may be added in a content ratio of 15 to 27 wt % of the total weight of the antibacterial glass composition according to embodiments disclosed herein. When the content amount of at least one of Na2O and K2O is less than 15 wt %, the flux could be insufficient enough to leave the vitrification region, which might cause unmelting. Conversely, when the content amount of at least one of Na2O and K2O exceeds 27 wt %, alkali ions might be easily replaced with H30+ ions of water based on the basic elution mechanism of glass, and a water resistance deterioration phenomenon in which dissolution is deepened might occur.

In this instance, Na2O may be added in an amount of 5 to 18 wt % and K2O added in an amount of 5 to 13 wt %. In addition, Na2O and K2O may be added in a range satisfying the following formula 1:

0.5≤[Na2O]/[K2O]≤1.5 [Formula 1]

where, [ ] represents a content ratio of each component. The effect of lowering the melting point through the eutectic point of Na2O—K2O may fall and virtrification might be escaped outside of the range of Formula 1 above.

Alkaline earth oxides, such as CaO, MgO, and WO3, are basic oxides that act as non-crosslinked modifying oxides in glass. These components may not be vitrified alone, but vitrification may be possible when mixed with a network former, such as SiO2 and B2O3, in a predetermined ratio. Unlike alkali oxides, alkaline earth oxides, such as CaO, MgO, and WO3, have +2 charge and have to be substituted with two water molecule ions, so that ion exchange may be relatively difficult and they may be sometimes used as durability enhancing elements. Therefore, alkaline earth oxides, such as CaO, MgO, and WO3, are used for the same purpose as alkali oxides, which structurally indirectly contribute to the expression of water insolubility and antibacterial properties by occupying the point of strong durability among the modified oxides and the site of the modifying oxide.

At least one of Cao, MgO, and WO3 may be added in a content ratio of 3 to 20 wt % of the total weight of the antibacterial glass composition according to embodiments disclosed herein. When at least one of CaO, MgO, and WO3 is less than 3 wt %, the structure cannot be strengthened at a modified oxide site and a water resistance deterioration that cannot prevent alkali elution might occur. Conversely, when at least one of CaO, MgO, and WO3 exceeds 20 wt %, the alkaline earth oxide, which melts at a high temperature, does not sufficiently melt and thus, leaves vitrification region, thereby causing formation of an unmelted material.

ZnO and SnO are components that perform both roles of a network-forming oxide and a modifying oxide by covalent bonding with some part of the network-forming oxide. In addition, ZnO and SnO are components that greatly contribute to the exhibition of the antibacterial effect.

These ZnO and SnO are intermediate oxides. Accordingly, in order to participate in the mesh formation structure in glass, they should have small atomic radius and the electronegativity should be large enough to the different with oxygen to be small. These intermediate oxides may refer to a component having a larger atomic radius and lower electronegativity than Si, P and B, which are conventional network-forming oxides, to make it difficult to form glass alone, but being substituted with the network-forming oxide in the presence of the network-forming oxide to play the role. ZnO and SnO may function only as modifying oxides below a predetermined amount, but they may form a covalent bond in a predetermined amount or more, thereby improving the durability radically. In this instance, the predetermined amount may be determined based on the content amount of the network forming oxide and the modifying oxide.

Accordingly, at least one of ZnO and SnO may be added in a content amount ratio of 22 to 44 wt % of the total weight of the antibacterial glass composition. When the content amount of at least one of ZnO and SnO is less than 22 wt %, the absolute amount of the substance exhibiting the antibacterial activity could be insufficient so that there might be a problem in that sufficient antibacterial activity may be exhibited. Conversely, when added in excess of 44 wt %, at least one of ZnO and SnO cannot exist as an ionic state in the glass under homogeneity, and it will partially forms crystals to leave the vitrification. Accordingly, oxygenation might appear due to the escape from the vitrification region and a heterogeneity phenomenon in which transparent glass is mixed might occur.

Ag2O, Ag3PO4 and AgNO3 may exist as ions in the glass and may be effective components to exhibit antibacterial activity. In addition, Ag2O, Ag3PO4, and AgNO3 may function to lower the melting point. When at least one Ag2O, Ag3PO4, and AgNO3 may be added in excess of 0.1 wt %, there is a risk of destabilizing vitrification due to precipitation of silver metal. Accordingly, at least one of Ag2O, Ag3PO4, and AgNO3 may be added in a strictly limited amount of 0.1 wt % or less of the total weight of the antibacterial glass composition according to embodiments disclosed herein.

Referring to the accompanying drawing, a method of manufacturing antibacterial glass powder according to an embodiment will be described.

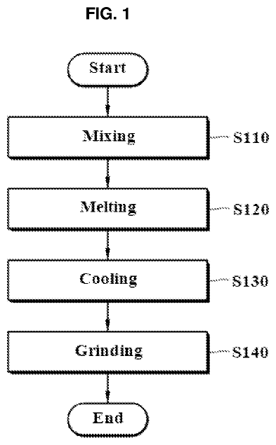

FIG. 1 is a flow chart of a method of manufacturing antibacterial glass powder according to an embodiment.

As shown in FIG. 1, the method of manufacturing the antibacterial glass powder may include mixing (S110), melting (S120), cooling (S130), and grinding (S140).

In the mixing process (S110), 26 to 50 wt % of SiO2, 0.5 to 4 wt % of at least one of B2O3 and P2O5, 15 to 27 wt % of at least one of Na2O and K2O, 3 to 20 wt % of at least one of CaO, MgO, and WO3, and 22 to 44 wt % of at least one of ZnO and SnO may be mixed and agitated, to form an antibacterial glass composition. The content amount of SiO2 may be higher than that of B2O3.

In addition, 5 to 18 wt % of Na2O may be added and 5 to 13 wt % of K2O may be added. Na2O and K2O may be added in a range which satisfies Formula 1 below.

0.5≤[Na2O]/[K2O]≤1.5 Formula 1:

where, [ ] represents the content ratio of each component.

The effect of lowering the melting point through the eutectic point of Na2O—K2O may fall and virtrification might be escaped outside of the range of Formula 1 above. In addition, the antibacterial glass composition may further include at least one of Ag2O, Ag3PO4, and AgNO3 in a content amount of 0.1 or more wt %.

In the melting process (S120), the antibacterial glass composition may be melted. In this process, melting may be performed at 1,100 to 1,400° C. for 1 to 60 minutes. If the melting temperature is lower than 1,100° C. or the melting time is less than 1 minute, the antibacterial glass composition may not be melted completely only, causing immiscibility of the glass melt. Conversely, if the melting temperature exceeds 1,400° C. or the melting time exceeds 60 minutes, excessive energy and time would be required, which is not economical.

In the cooling process (S130), the melted antibacterial glass composition may be cooled to a room temperature. In this process, cooling may be performed in a furnace cooling method. When air cooling or water cooling is applied, the internal stress of the antibacterial glass might be severely formed and cracks could occur in some cases. Accordingly, the finance cooling method may be advantageous.

In the grinding process (S140), the cooled antibacterial glass may be grinded. For the grinding, any one selected from commonly known ball mills, jet mills, and planetary mills, for example, may be applied. The antibacterial glass may be grinded into fine antibacterial glass powder, to prepare the antibacterial glass power. The antibacterial glass powder may have an average diameter of 30 μm or more, and an average diameter of 5 to 15 μm.

Through the above-described processes (S110) to (S140), the antibacterial glass powder according to an embodiment may be prepared.

A hole appliance according to an embodiment may include a resin material and a plastic injection molded material made by adding the antibacterial glass power prepared by the above-described method to the resin material. The home appliance used in embodiments disclosed herein may include a water purifier, a washing machine and a stand air conditioner, a system air conditioner, and a refrigerator for example; however, embodiments are not limited thereto.

The plastic injection molded material may include 95.0 to 99.0 wt % of the resin and 1.0 to 5.0 wt % of the antibacterial glass powder. When the added amount of the antibacterial glass powder is less than 1.0 wt % of the total content amount of the plastic injection molded material, the antibacterial activity against P. aeruginosa might not be sufficient. Conversely, when the added amount of the antibacterial glass composition exceeds 5.0 wt % of the total content amount of the plastic injection molded material to be added excessively, there is a possibility that mechanical properties could be deteriorated.

The resin material may include at least one of polypropylene (PP), polycarbonate (PC), ethylene propylene rubber (EPDM), acrylonitrile-buradiene-styrene (ABS) and high impact polystyrene (HIPS). In this instance, the antibacterial glass powder may include 26 to 50 wt % of SiO2, 0.5 to 4 wt % of at least one of B2O3 and P2O5, 15 to 27 wt % of at least one of Na2O and K2O, 3 to 20 wtT of at least one of CaO, MgO, and WO4, and 22 to 44 wt % of at least one of ZnO and SnO.

5 to 18 wt % of Na2O and 5 to 13 wt % of K2O may be added. In addition, Na2O and K2O may be added in a range satisfying Formula 1 below.

0.5≤[Na2O]/[K2O]≤1.5 Formula 1:

where, H represents the content ratio of each component. The effect of lowering the melting point through the eutectic point of Na2O—K2O may fall and virtrification might be escaped outside of the range of Formula 1 above.

In addition, the plastic injection molded material may further contain a functional additive rather than the antibacterial glass powder. The functional additive may include at least one selected from an antioxidant, a forming agent, an impact modifier, a nucleating agent, and a coupling agent, for example.

Accordingly, a home appliance according to embodiments disclosed herein may have an antibacterial power that prevent inhabitation and growth of various microorganisms, because the antibacterial activity is given to a surface of the home appliance which is vulnerable to bacterial propagation and comes in contact with a lot of moisture.

Hereinafter, a configuration and activation of embodiments disclosed herein will be described. However, examples are presented and should not be construed as limiting in any sense. The features not described herewith may be derived by people skilled in the art to which embodiments disclosed herein pertain, thereby being omitted.

1. Manufacturing an Antibacterial Glass Power Sample:

Table 1 shows a composition and composition ratio of an antibacterial glass composition according to Examples 1 to 10. Table 2 shows compositions and a composition ratio of an antibacterial glass composition according to Comparative examples 1 to 8. The antibacterial glass compositions having the compositions disclosed in Examples 1 to 10 and Comparative Examples 1 to 8 are melted at 1,200° C. in an electric furnace and then cooled in the form of glass bulk on a stainless steel plate by air cooling. Only in Examples 1 to 10 and Comparative Examples 2, 4 and 5, cullet type antibacterial glass is achieved. After that, the antibacterial glass prepared according to Examples 1 to 10 and Comparative Examples 2, 4 and 5 may be grinded using a ball mill, and then passed through a mesh sieve to prepare an antibacterial glass powder sample.

In this instance, as raw materials for Na2O, K2O, and CaO, Na2CO3, K2CO3, and CaCO3 are used, respectively, and the other components are the same as those described in Table 1 and Table 2. In addition, vitrification is classified based on homogeneous glassy appearance and opacification and non-melting phenomenon.

TABLE 1
(Unit: wt %)

| | Examples | | | | | | | | | |
|---|---|---|---|---|---|---|---|---|---|---|
| Classification | 1 | 2 | 3 | 4 | 5 | 6 | 7 | 8 | 9 | 10 |
| SiO₂ | 26.0 | 40.0. | 35.1 | 35.0 | 35.1 | 31.0 | 35.1 | 31.0 | 40.0 | 34.0 |
| P₂O₅ | — | — | 1.8 | — | — | — | — | — | — | — |
| B₂O₃ | 2.0 | 3.8 | — | 3.9 | 2.0 | 2.0 | 2.0 | 2.0 | 3.8 | 1.9 |
| Na₂O | 11.0 | 12.2 | 9.6 | 10.7 | 7.1 | 16.0 | 9.6 | 11.0 | 12.2 | 8.4 |
| K₂O | 11.0 | 6.7 | 9.6 | 8.7 | 9.6 | 11.0 | 9.6 | 11.0 | 6.7 | 8.4 |
| WO₃ | — | 4.0 | — | — | — | — | — | — | 4.0 | 4.0 |
| CaO | 10.0 | 11.1 | 8.8 | 9.7 | 8.8 | 5.0 | 4.3 | 20.0 | 11.1 | — |
| MnO₂ | — | — | — | — | — | — | — | — | — | — |
| SnO | — | — | 2.0 | 2.9 | — | — | — | — | — | — |
| ZnO | 40.0 | 22.2 | 33.1 | 29.1 | 37.3 | 35.0 | 39.3 | 25.0 | 22.2 | 43.4 |
| Total | 100 | 100 | 100 | 100 | 100 | 100 | 100 | 100 | 100 | 100 |

TABLE 2
(unit: wt %)

| | Comparative examples | | | | | | | |
|---|---|---|---|---|---|---|---|---|
| Classification | 1 | 2 | 3 | 4 | 5 | 6 | 7 | 8 |
| SiO₂ | 25.4 | 53.0 | 36.0 | 35.1 | 26.0 | 31.0 | 26.0 | 35.1 |
| P₂O₅ | — | 4.0 | — | — | — | — | — | — |
| B₂O₃ | 2.2 | — | — | 6.8 | 2.0 | 2.0 | 1.7 | 2.0 |
| Na₂O | 11.9 | 15.0 | 12.0 | 10.7 | 16.6 | 11.0 | 9.5 | 7.1 |
| K₂O | 11.9 | — | 12.0 | 5.9 | 12.6 | 11.0 | 9.5 | 7.1 |
| WO₃ | — | — | — | — | — | — | — | — |
| CaO | 10.8 | 18.0 | 10.0 | 9.8 | 2.8 | 25.0 | 8.6 | 11.3 |
| MnO₂ | — | — | — | 12.2 | — | — | — | — |
| SnO | — | — | — | — | — | — | — | — |
| ZnO | 37.8 | 10.0 | 30.0 | 19.5 | 40.0 | 20.0 | 44.7 | 37.3 |
| Total | 100 | 100 | 100 | 100 | 100 | 100 | 100 | 100 |

2. Antibacterial Glass Powder Properties Evaluation Results

Table 3 shows physical property evaluation results for samples prepared according to Examples 1 to 10. Table 4 shows results of evaluation of physical properties for samples prepared according to Comparative Examples 1 to 8.

1) Antibacterial Activity Measurement:

For Examples 1 to 10 and Comparative Examples 1, 4 and 5 in which vitrification is homogenously progressed, 4 bacteria (Staphylococcus aureus, Escherichia coli, Klebsiella pneumoniae, Pseudomonas) based on the shaking flask method (ASTM E2149-13a) aeruginosa) is evaluated for antibacterial activity.

2) Chemical Durability Evaluation:

In order to evaluate the durability of Examples 1 to 10 and Comparative Examples 2, 4, and 5 in which vitrification is performed homogenously, it is evaluated whether the dissolution level for the elements limited in Table 5 below passes WHO guide and domestic drinking water standards through the ASTM C1285-14 (glass and glass-ceramic durability evaluation method) test method. In this instance, the chemical durability is indicated by 0 when the elution amount for each component listed in Table 5 is less than a reference value at 50° C. and 32 hours, and indicated by X when the elution amount is higher than the reference value.

TABLE 3

| | | Examples | | | | | | | | | |
|---|---|---|---|---|---|---|---|---|---|---|---|
| classification | | 1 | 2 | 3 | 4 | 5 | 6 | 7 | 8 | 9 | 10 |
| Vitrification (◯, X) | | ◯ | ◯ | ◯ | ◯ | ◯ | ◯ | ◯ | ◯ | ◯ | ◯ |
| Antibacterial | Staphylococcus | 99.9% | 99.9% | 99.9% | 99.9% | 99.9% | 99.9% | 99.9% | 99.9% | 99.9% | 99.9% |
| activity | aureus | | | | | | | | | | |
| | Escherichia | 99.9% | 99.9% | 99.9% | 99.9% | 99.9% | 99.9% | 99.9% | 99.9% | 99.9% | 99.9% |
| | coil | | | | | | | | | | |
| | Klebsiella | 99.9% | 99.9% | 99.9% | 99.9% | 99.9% | 99.9% | 99.9% | 99.9% | 99.9% | 99.9% |
| | pneumoniae | | | | | | | | | | |
| | Pseudomonas | 99.9% | 99.9% | 99.9% | 99.9% | 99.9% | 99.9% | 99.9% | 99.9% | 99.9% | 99.9% |

| | | | | | | | | | | |
|---|---|---|---|---|---|---|---|---|---|---|
| Chemical durability | 0 | 0 | 0 | 0 | 0 | 0 | 0 | 0 | 0 | 0 |

TABLE 4

| | | Example | | | | | | | |
|---|---|---|---|---|---|---|---|---|---|
| | | Vitrification (◯, X) | | | | | | | |
| | | | | | | | X Presence of | | X Presence of |
| | | | | | | | unmelted | X | unmelted |
| classification | | opalescence | ◯ | unmelted | ◯ | ◯ | (heterogenous) | opalescence | (heterogenous) |
| Antibacterial | Staphylococcus | — | 47.2% | — | 60% | 99.9% | — | — | — |
| activity | aureus | | | | | | | | |
| | Escherichia | — | 32.0% | — | 54.2% | 99.9% | — | — | — |
| | coil | | | | | | | | |
| | Klebsiella | — | 29.8% | — | 52% | 99.9% | — | — | — |
| | pneumoniae | | | | | | | | |
| | Pseudomonas | — | 65.4% | — | 79.9% | 99.9% | — | — | — |

| | | | | | |
|---|---|---|---|---|---|
| Chemical durability | — | ◯ | — | X | X |

TABLE 5

| Elution amount | B | Zn | Mn |
|---|---|---|---|
| WHO guide | 2.4 | — | — |
| Domestic drinking | 1.0 | 3 | 0.05 |
| water | | | |

As shown in Table 1 to 5, the samples prepared according to Examples 1 to 10 have the antibacterial activity of 99% or more against all four bacteria. In contrast, vitrification did not proceed homogenously in Comparative examples 1 to 8 except for Comparative examples 2, 4 and 5.

In addition, the sample prepared according to Comparative example 5 have an antibacterial activity of 99% against all 4 bacteria. However, the sample prepared according to Comparative examples 2 and 4 has an antibacterial activity of 80% or less against all four bacteria.

When using the samples prepared according to Examples 1 to 10, it is confirmed that elution did not occur for B, Zn and Mn components as a result of durability measurement, which indicates excellent chemical durability. In contrast, elution did not occur in the sample prepared according to Comparative example 2, but elution occurred in the sample prepared according to Comparative examples 4 and 5, resulting in poor chemical durability.

3. Injection Molded Product Manufacturing

Table 6 shows the results of evaluating the antibacterial effect of the injection molded product manufactured according to Example 3, Example 7, Comparative example 2 and Comparative example 4. 2 wt % of the antibacterial glass powder prepared according to Examples 3 and 7 and Comparative examples 2 and 4 is mixed with 98 wt % of PP (Polypropylene) resin. After that, injection molding is performed using an injection molding machine and injection molded products of 200 mm (horizontal), 100 mm (length) and 2 mm (thickness) are manufactured. In order to confirm the antibacterial degree of each injection molded product, the antibacterial activity against Staphylococcus aureus and E. coli was measured by ASTM E2149-13a, the shaking flask method. In addition, the antibacterial activity against pneumococcus and Pseudomonas aeruginosa is further evaluated.

TABLE 6

| | Antibacterial activity | | | |
|---|---|---|---|---|
| | (JIS Z 2801, Film adhesion method) | | | |
| | | | Comparative | Comparative |
| | Example 3 | Example 7 | example 2 | example 4 |
| Staphylococcus | 99.99% | 99.99% | 49.1% | 59.8% |
| aureus | | | | |
| Escherichia coil | 99.99% | 99.99% | 39.6% | 55.6% |
| Klebsiella | 99.99% | 99.99% | 31.2% | 52.1% |
| pneumonia | | | | |
| Pseudomonas | 99.99% | 99.99% | 63.1% | 76.3% |
| aeruginosa | | | | |

As shown in Table 6, the injection molded products manufactured according to Examples 3 and 7 are measured to have an antibacterial activity value of 2.0 or higher, which confirms that they exhibit an antibacterial activity of 99% or higher. In contrast, the injection molded products manufactured according to Comparative examples 2 and 4 are measured to have an antibacterial activity value of less than 2.0, which confirms that they exhibit an antibacterial activity of 80% or lower. As seen based on the above-described experimental results, it is confirmed that the injection molded products manufactured according to Examples 3 and 7 exhibit excellent antibacterial activity, compared to the injection molded products manufactured according to Comparative examples 2 and 4.

Embodiments are described above with reference to a number of illustrative embodiments thereof. However, embodiments disclosed herein are not intended to limit the embodiments and drawings set forth herein, and numerous other modifications and embodiments may be devised by one skilled in the art. Further, the effects and predictable effects based on the configurations are to be included within the range of the disclosure though not explicitly described in the description of the embodiments.

1. An antibacterial glass composition, comprising:
26 to 50 wt % of silicon dioxide (SiO₂);
0.5 to 4 wt % of at least one of boric oxide (B₂O₃), and phosphorous pentoxide (P₂O₅);
15 to 27 wt % of at least one of sodium oxide (Na₂O), and potassium oxide (K₂O);
3 to 20 wt % of at least one of calcium oxide (CaO), magnesium oxide (MgO) and tungsten trioxide (WO₃); and
22 to 44 wt % of zinc oxide (ZnO), and tin oxide (SnO).

2. The antibacterial glass composition of claim 1, wherein a content amount of the SiO2 is greater than a content amount of the B₂O₃.

3. The antibacterial glass composition of claim 2, wherein the SiO2 is added in a content amount of 30 to 36 wt %.

4. The antibacterial glass composition of claim 1, wherein the Na₂O is added in a content amount of 5 to 18 wt %, and the K₂O is added in a content amount of 5 to 13 wt %.

5. The antibacterial glass composition of claim 4, wherein the Na₂O and the K₂O are added in a content range satisfying Formula 1 below:
0.5≤[Na₂O]/[K₂O]≤1.5 Formula 1:
where, [ ] represents a content ratio of each component.

6. The antibacterial glass composition of claim 1, further comprising:
0.1 wt % or less of at least one of silver oxide (Ag₂O), silver phosphate (Ag₃PO₄), and silver nitrate (AgNO₃).

7. A method of manufacturing antibacterial glass powder, the method comprising:
mixing and agitating 26 to 50 wt % of silicon dioxide (SiO₂), 0.5 to 4 wt % of at least one of boric oxide (B₂O₃), and phosphorous pentoxide (P₂O₅), 15 to 27 wt % of at least one of sodium oxide (Na₂O), and potassium oxide (K₂O), 3 to 20 wt % of at least one of calcium oxide (CaO), magnesium oxide (MgO), and tungsten trioxide (WO₃), and 22 to 44 wt % of zinc oxide (ZnO), and tin oxide (SnO) to form an antibacterial glass composition;
melting the antibacterial glass composition;
cooling the melted antibacterial glass composition; and
grinding the cooled antibacterial glass.

8. The method of manufacturing the antibacterial glass powder of claim 7, wherein in the mixing and agitating, a content amount of the SiO₂ is greater than a content amount of the B₂O₃.

9. The method of manufacturing the antibacterial glass powder of claim 8, wherein the SiO₂ is added in a content amount of 30 to 36 wt %.

10. The method of manufacturing the antibacterial glass powder of claim 7, wherein in the mixing and agitating, the Na₂O is added in a content amount of 5 to 18 wt %, and the K₂O is added in a content amount of 5 to 13 wt %.

11. The method of manufacturing the antibacterial glass powder of claim 10, wherein the Na₂O and the K₂O are added in a content range satisfying Formula 1 below:
0.5≤[Na₂O]/[K₂O]≤1.5 Formula 1:
where, [ ] represents a content ratio of each component.

12. The method of manufacturing the antibacterial glass powder of claim 7, wherein in the mixing and agitating, the antibacterial glass composition further comprises 0.1 wt % or less of at least one of silver oxide (Ag₂O), silver phosphate (Ag₃PO₄), and silver nitrate (AgNO₃).

13. The method of manufacturing the antibacterial glass powder of claim 7, wherein in the melting of the antibacterial glass composition, the melting is performed at 1,100 to 1,400° C. for 1 to 60 minutes.

14. A home appliance, comprising:
a plastic injection molded material in which an antibacterial glass powder is added to a resin material, wherein the plastic injection molded material includes:
95.0 to 99.0 wt % of the resin material; and
1.0 to 5.0 wt % of the antibacterial glass powder, and wherein the antibacterial glass powder includes 26 to 50 wt % of silicon dioxide (SiO₂), 0.5 to 4 wt % of at least one of boric oxide (B₂O₃), and phosphorous pentoxide (P₂O₅), 15 to 27 wt % of at least one of sodium oxide (Na₂O), and potassium oxide (K₂O), 3 to 20 wt % of at least one of calcium oxide (CaO), magnesium oxide (MgO), and tungsten trioxide (WO₃), and 22 to 44 wt % of zinc oxide (ZnO), and tin oxide (SnO).

15. The home appliance of claim 14, wherein the resin material includes at least one of polypropylene (PP), polycarbonate (PC), ethylene propylene rubber (EPDM), acrylonitrile-buradiene-styrene (ABS), and high impact polystyrene (HIPS).

16. The home appliance of claim 14, wherein the Na₂O is added in a content amount of 5 to 18 wt %, and the K₂O is added in a content amount of 5 to 13 wt %.

17. The home appliance of claim 14, wherein the Na₂O and the K₂O are added in a content range satisfying Formula 1 below:
0.5≤[Na₂O]/[K₂O]≤1.5 Formula 1:
where, [ ] represents a content ratio of each component.

18. An antibacterial glass composition manufactured using the method of claim 7.
